(19) United States
(12) Patent Application Publication
(10) Pub. No.: US 2020/0143366 A1
(43) Pub. Date: May 7, 2020

(54) METHODS FOR DECENTRALIZED DIGITAL ASSET TRANSFER AND SMART CONTRACT STATE TRANSITION

(71) Applicant: Vite Labs Limited, Road Town (VG)

(72) Inventors: Chunming Liu, Beijing (CN); Lingyong Zhang, Beijing (CN); Yi Zhu, Beijing (CN)

(21) Appl. No.: 16/194,299

(22) Filed: Nov. 17, 2018

Related U.S. Application Data
(63) Continuation of application No. 16/179,149, filed on Nov. 2, 2018.

(51) Int. Cl. G06Q 20/38; G06F 17/30; H04L 9/06

(52) U.S. Cl. CPC G06Q 20/389; G06F 17/30283; G06F 17/30377; H04L 2209/38; G06F 17/30958; H04L 9/0643; H04L 9/0637

(57) ABSTRACT

Provided is a method for digital assets transfer or smart contract state transition on a distributed ledger using a snapshot chain that comprises a series of snapshot blocks linked by hash reference. The distributed ledger comprises a plurality of accounts, each account having an account chain comprising a series of blocks linked by hash reference. The global consensus of the distributed ledger is recorded in the snapshot chain.

### CROSS-REFERENCE TO RELATED APPLICATION

This application is a divisional application of U.S. application Ser. No. 16/179,149, filed Nov. 2, 2018, the disclosure of which is incorporated herein by reference.

### FIELD OF THE INVENTION

The present invention generally relates to decentralized digital assets transfer, smart contract state transition and decentralized applications.

### BACKGROUND

A decentralized application (dApp) platform is a distributed system with final consistency of states among the nodes. DApp platforms have been used to facilitate the transfer of digital assets, such as cryptocurrencies, and to execute a set of smart contracts which have their own internal states and transition logics. In realistic scenarios, what is stored in the state of smart contracts is a set of completed data in a dApp, which has large volume and cannot be transmitted between nodes. Therefore, nodes need to transfer a set of transactions to achieve the consistency of the final state. Such a set of transactions are organized into a specific data structure, which usually referred to as ledgers. Examples of the ledgers include, without limitation, a block chain, and a directed acyclic graph (DAG).

In certain situations, a different order of the same set of transactions may cause the system to enter a different state. When this happens, it is usually called a “fork.” When the fork occurs, each node needs to select one from multiple forked ledgers. In order to ensure the consistency of the state, the nodes need to use the same algorithm to complete the selection. This algorithm is called the consensus algorithm. A good consensus algorithm should possess high convergence speed to reduce the sway of consensus in different forks and have a high ability to guard against malicious attacks.

Ethereum took the lead in realizing a universal decentralized application platform. The ledger structure of Ethereum is a block chain, which is made up of blocks. Each block contains a list of transactions, and the latter block refers to the hash of the previous block to form a chain structure. The greatest advantage of this structure is to effectively prevent transactions from being tampered with. But because it maintains the full order of all transactions, the exchange of two transaction orders will generate a new ledger, which has a higher probability of fork. The consensus algorithm of Ethereum is called proof-of-work (PoW), which relies on a mathematical problem that is easily verifiable but difficult to solve. The PoW consensus algorithm has better security and has been running well in Bitcoin and Ethereum. However, there are two main problems in this algorithm. The first is to solve a mathematical problem that requires a large amount of computing resources, resulting in a waste of energy. The second is the slow convergence speed of the algorithm, thus affecting the system's overall throughput. At present, the transactions-per-second (TPS) of Ethereum is about 15, which is totally unable to meet the needs of decentralized applications.

With the proliferation of digital assets, there is an increased need to develop a universal dApp platform that can solve the problems above and has high throughput and low latency while taking into account security.

### SUMMARY

The present disclosure in one aspect provides a method for digital assets transfer or smart contract state transition on a distributed ledger using a snapshot chain that comprises a series of snapshot blocks linked by hash reference. The distributed ledger comprises a plurality of accounts, each account having an account chain comprising a series of blocks linked by hash reference. The global consensus of the distributed ledger is recorded in the snapshot chain.

In one embodiment, the method comprises: verifying that a first transaction in the latest block of a first account is valid; taking a first snapshot of the first account, wherein the first snapshot comprises: the first account's balance upon completing the first transaction, and a hash of the latest block of the first account; and storing the first snapshot in the latest snapshot block of the snapshot chain.

In some embodiments, the distributed ledger has a structure of directed acyclic graph.

In some embodiments, the first transaction is a request transaction that sends an amount of digital asset to a second account or invokes a smart contract that deployed on a second account. In some embodiments, the verifying step comprises: verifying that a hash of the previous block linked to the latest block is valid; and verifying that the first account's balance prior to the first transaction is not less than the amount of digital asset.

In some embodiments, the first transaction is a response transaction that receives an amount of digital asset or executes a smart contract state transition from a corresponding request block of a second account. In some embodiments, the verifying step comprises: verifying that a hash of the previous block linked to the latest block is valid; and verifying that the hash of the corresponding request block is valid.

In some embodiments, the first snapshot further comprises a Merkle root of the first account's contract state.

In some embodiments, the latest snapshot block is signed by a node in the network that produces the latest snapshot block.

In some embodiments, the method further comprises the step of broadcasting the latest snapshot block to the network.

The present disclosure in another aspect provides a non-transitory readable storage medium including instructions, executable by a processor in a node of a network, for a method of transferring digital assets or invoking a smart contract on a distributed ledger.

In yet another aspect, the present disclosure provides a system for digital assets transfer or smart contract state transition on a distributed ledger that comprises a plurality of accounts, each account having an account chain comprising a series of blocks linked by hash reference. In some embodiments, the system comprises a node in a network which records global consensus of the distributed ledger in a snapshot chain comprising a series of snapshot blocks linked by hash reference.

### BRIEF DESCRIPTION OF DRAWINGS

The accompanying drawings, which are incorporated herein, form part of the specification. Together with this written description, the drawings further serve to explain the principles of, and to enable a person skilled in the relevant art(s), to make and use the present invention.

FIG. 1 illustrates exemplary structures of distributed ledgers.

FIG. 2 illustrates the split of an exemplary transfer transaction into a request transaction and a response transaction.

FIG. 3 illustrates an exemplary embodiment of transactions on a distributed ledger having a DAG structure and an exemplary snapshot chain.

FIGS. 4A and 4B illustrate an exemplary snapshot chain before the compression (FIG. 4A) and after compression (FIG. 4B).

### DESCRIPTION OF THE INVENTION

The following description of the disclosure is merely intended to illustrate various embodiments of the disclosure. As such, the specific modifications discussed are not to be construed as limitations on the scope of the disclosure. It will be apparent to one skilled in the art that various equivalents, changes, and modifications may be made without departing from the scope of the disclosure, and it is understood that such equivalent embodiments are to be included herein. All references cited herein, including publications, patents and patent applications are incorporated herein by reference in their entirety.

### Definition

The following definitions are provided to assist the reader. Unless otherwise defined, all terms of art, notations and other scientific or medical terms or terminology used herein are intended to have the meanings commonly understood by those of skill in the art. In some cases, terms with commonly understood meanings are defined herein for clarity and/or for ready reference, and the inclusion of such definitions herein should not necessarily be construed to represent a substantial difference over the definition of the term as generally understood in the art.

As used herein, the singular forms “a”, “an” and “the” include plural references unless the context clearly dictates otherwise.

As used herein, an “address” or “network address” refers to an identifier for a node or host on a telecommunication network. Typically, addresses are designed to be unique identifiers across the network. Examples of network addresses include, without limitation, IP address, IPX address, MAC address, etc.

A “block,” as used in the context of a distributed ledger, refers to a file where data pertaining to the distributed ledger is recorded. A block can record some or all of the most recent transactions in the distributed ledger that have not yet entered any prior block.

“Blockchain” or “block chain” refers to a continually growing list of records, i.e., blocks, that are linked and secured using cryptography. Each block typically contains a cryptographic hash of the previous block, a timestamp and transaction data. A blockchain, by design, is inherently resistant to modification of the data. Blockchain can be used as an open, distributed ledger that records transactions between two parties efficiently and in a verifiable and permanent way. When used as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

“Block lattice” refers to a type of DAG (Directed Acyclic Graph) based architecture. With this type of architecture, each individual account on the network possesses their own blockchain, which is controlled by the individual's private keys or a group of delegated nodes.

The term “cryptographic hash” or “hash” refers to a mathematical algorithm that maps data of arbitrary size to a bit string of a fixed size, and is designed to be a one-way function, that is, a function which is infeasible to invert. The only way to recreate the input data from an ideal cryptographic hash function's output is to attempt a brute-force search of possible inputs to see if they produce a match or use a rainbow table of matched hashes. A hash function is a deterministic function, in which the same input will produce the same output. Examples of cryptographic hash include SHA hash function, e.g., SHA-0, SHA-1, SHA-2 and SHA-3 function.

The term “consensus algorithm” as used herein refers to a mechanism or process through which the members in a distributed ledger reaches agreement. Examples of consensus algorithm includes without limitation, proof-of-work (PoW), proof-of-stake (PoS), delegated proof-of-stake (DPoS), transaction as proof-of-stake (TAPoS), Byzantine fault tolerance (BFT).

As used herein, a “digital signature” refers to a mathematical scheme for presenting the authenticity of digital messages or documents. A valid digital signature gives a recipient reason to believe that the message was created by a known sender, that the sender cannot deny having sent the message and that the message was not altered in transit. A typical digital signature scheme consists of three algorithms: a key generation algorithm that selects a private key uniformly at random from a set of possible private keys and outputs the private key and a corresponding public key; a signing algorithm that, given a message and a private key, produces a signature; and a signature verification algorithm that, given the message, public key and signature, either accepts or rejects the message's claim to authenticity. Examples of digital signature algorithm include, without limitation, RSA based signature schemes (e.g., RSA-PSS), DSA, Edwards-curve digital signature algorithm, Rabin signature algorithm, aggregate signature, etc.

“Distributed ledger” refers to a database that is consensually shared and synchronized across network spread across multiple nodes, sites, institutions or geographies. Distributed ledger allows transactions to have public witnesses, thereby making a cyberattack more difficult. A peer-to-peer network is usually required as well as consensus algorithm to ensure replication in nodes is undertaken. One form of distributed ledger is the blockchain system, which can be either public or private. Distributed ledger may employ a system with various structure, such as block chain and DAG, to provide secure and valid achievement of distributed census.

A “fork” as used herein refers to a situation in which a distributed ledger diverges into two potential paths forward.

“Merkle root” refers to the root node of a Merkle tree. A Merkle tree, or hash tree, is a tree in which every leaf node is labelled with the hash of a data block and every non-leaf node is labelled with the cryptographic hash of the labels of its child nodes. Thus, a Merkle root is a descendent of all the hashed pairs in the tree.

As used herein, a “smart contact” refers to a computer protocol intended to digitally facilitate, verify or enforce the negotiation or performance of a contract. Smart contracts allow the performance of credible transactions without third parties. These transactions are trackable and irreversible. For example, smart contracts implemented on Ethereum may include those that defines the interfaces and events, that registers wallets and relays, that validates order rings, transfers tokens for settlement and emits events, that enables multi-signature ownership, and that transfers tokens on behalf of users.

As used herein, a “snapshot” or “state snapshot” refers to the state of a system, e.g., a distributed ledger or an account in the distributed ledger, at a particular point of time. In the context of an account in a distribute ledger, a state snapshot may include the balance of an account. The state snapshot may also include the hash of the last block in each account chain. In some examples, the state snapshot may also include the Merkle root of the contract state.

The present disclosure in one aspect provides methods and systems for facilitating digital asset transfer and smart contract state transition. It is understandable to those skilled in the art that such methods are implemented in a distributed network which may include one or more computer servers and devices that are connected and communicated with each other. Correspondingly, the systems disclosed herein include both hardware, such as computer servers and devices, and software. Suitable computer servers include, without limitation, a rack server, a tower server, a miniature server, a blade server, a mini rack server, a mobile server, an ultra-dense server, a super server, and may include various hardware components, for example, a mother board, a processing unit, memory systems, hard drives, network interfaces, power supplies, etc. The computer systems or devices may run an operating system including any commercial available server operating system. The computer servers and devices may be connected and communicated through various types of networks, for example, computer networks, telecommunications networks, wireless networks, and any combinations of these an/or other networks.

Ledgers

In the field of digital asset transaction, the role of ledgers is to determine the order of transactions, which will affect the following two aspects: consistency of status and effectiveness of hash. Since the state of the system is not a conflict-free replicated data types (Shapiro Marc et al., 2011), not all transaction is exchangeable, and the sequence of different transaction execution may lead to the system entering a different world state. In the ledger, the transaction will be packaged into blocks, which contain hash that is referenced to each other. The order of transactions affects the connectivity of hash references in the ledgers. The greater the scope of this impact, the greater the cost of tampering with transactions. This is because any change to a transaction must be rebuilt by hash, which directly or indirectly refers to the block of the transaction.

Thus, the design of the ledger has two main objectives: reducing the false fork rate and tamper proof.

The reduction of the false fork rate can be achieved by establishing an equivalent class and combining a group of accounts that lead the system into the same state into a single account. In other words, partial ordering relationship between transactions should be minimized to allow more transactions to be exchanged by sequence.

On the other hand, to increase the cost of tampering with transactions, it is necessary to maintain the partial order relationship between transactions as much as possible in order to expand the scope of tampering.

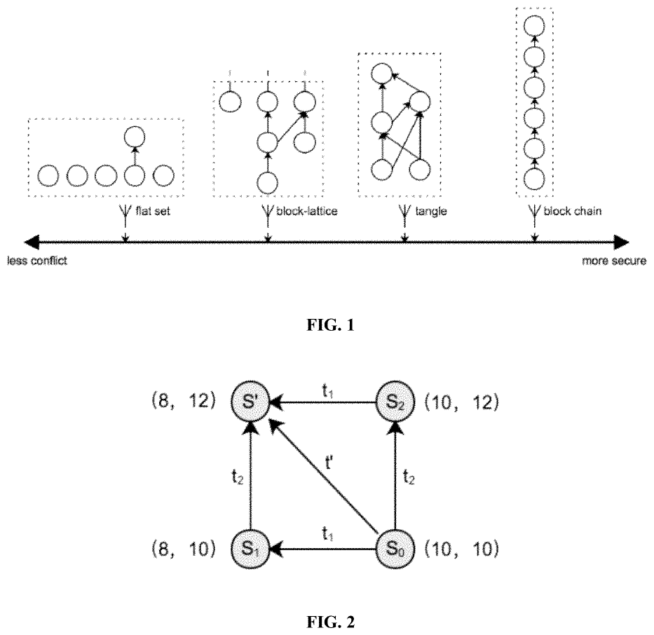

Obviously, the two main objectives above are contradictory, and the necessary trade-offs must be made when designing the account structure. FIG. 1 compares several common ledger structures, and the ledgers near the left are maintained with less partial order and has a lower false fork rate; the ledgers near the right side maintain more partial order relationships and are more tamper-resistant. In FIG. 1, the most-left side is a common set-based structure in a centralized system without any tampering-proof features; the most right side is a typical blockchain ledger with the best tampering-proof features; between the two, there are two directed acyclic graph (DAG) ledgers, the block lattice account used by Nano and the Tangle used by IOTA.

The block lattice structure is essentially a combination of a set of independent accounts, and each account has an independent state. In a ledger of block lattice structure, all transactions are grouped into accounts and organized into a chain of transactions in the same account. In terms of characteristics, block lattice maintains less partial order relations and is more suitable for the accounting structure of high-performance decentralized application platforms. However, because of its poor anti-tampering characteristics, it is vulnerable to attacks.

In certain embodiments, in a ledger having a block lattice structure, each transaction only affects the state of an account, which is referred to as having a single degree of freedom constraint for a transaction. In contrast, in a ledger having a blockchain structure, such as Bitcoin and Ethereum, a transaction may affect the state of multiple accounts. For example, a transaction in Bitcoin will change the state of the two accounts of the sender and the recipient; the Ethereum may change the state of more than two accounts in a message call.

In a ledger having a block lattice structure, the relationship between transactions can be simplified. Any two transactions are either orthogonal (the accounts of the two transactions are different) or parallel (the account of the two transactions is the same). This provides conditions for grouping transactions according to accounts.

FIG. 2 illustrates the slip of a transfer transaction into a sending transaction and a receiving transaction. As shown in FIG. 2, suppose Alice and Bob have 10 USD respectively. The initial state of the system is s₀=(10, 10). When Alice wants to transfer 2 USD to Bob, in the model of Bitcoin and Ethereum, a transaction t′, can make the system go directly into the final state:

$${s}_{0} {\to }^{{t}^{′}} {s}^{′} .$$

In a ledger having DAG structure, transaction t′ changes the status of two accounts of Alice and Bob as well, which did not conform to the principle of single degree of freedom. Therefore, the transaction must be split into two transactions:

1) A transaction t₁ that represents sending of 2 USD by Alice

2) A transaction t₂ that represents receiving of 2 USD by Bob

In this way, from the initial state to the final state s′ there could be two different paths

$${s}_{0} {\to }^{{t}_{1}} {s}_{1} {\to }^{{t}_{2}} {s}^{′} and {s}_{0} {\to }^{{t}_{2}} {s}_{2} {\to }^{{t}_{1}} {s}^{′} .$$

These two paths are respectively passed through the intermediate state s₁ and s₂, and these two intermediate states are the mapping of the final state s′ in the two account dimensions. In other words, if the state of only one of the accounts is concerned, only all the transactions that correspond to the account need to be executed, and no transactions of other accounts need to be carried out.

Therefore, a transfer transaction can be split into a sending transaction and a receiving transaction. Similarly, a message call within a smart contract can be split into a contract request transaction and a contract response transaction.

A sending transaction or contract request transaction, collectively refer to as a “request transaction”; a receiving transaction or a contract response transaction, collectively refer to as a “response transaction”. A request transaction and a corresponding response transaction are called a transaction pair.

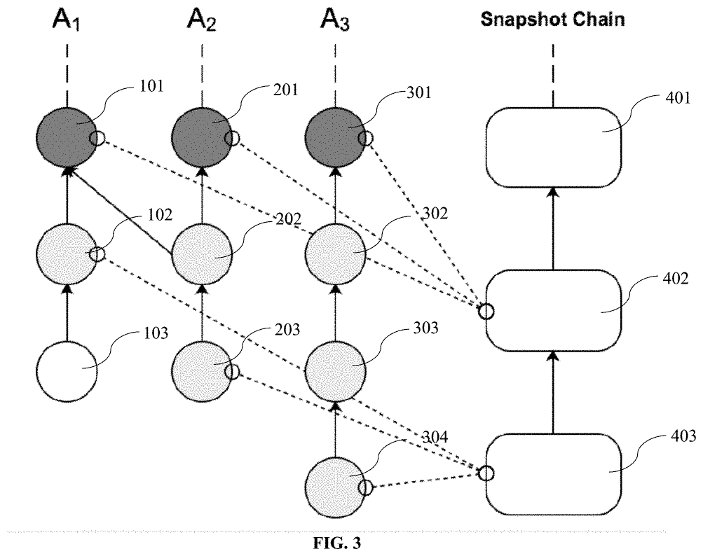

FIG. 3 illustrates an exemplary embodiment of transactions on a distributed ledger having a DAG structure. Now referring to FIG. 3, circles represent transactions, and arrows denote dependencies between transaction, whereas a b indicates that a depends on b. In other words, block a contains a hash reference to block b. Transactions are divided into request and response transactions, each of which corresponds to a separate block. Each account A₁, A₂, A₃ and A₄ corresponds to a chain of blocks, which are linked by hash references (i.e., each block refers to the hash of its immediately previous block except for the first block in the chain). A response transaction refers to the hash of its corresponding request transaction.

Referring to FIG. 3, block chain A₁ includes at least blocks 101, 102 and 103, wherein block 102 depends on block 101 and block 103 depends on block 102. Block chain A₂ includes at least blocks 201, 202 and 203, wherein block 202 depends on block 201 and block 203 depends on block 202. Block chain A₃ includes at least blocks 301, 302, 303 and 304, wherein block 302 depends on block 301, block 303 depends on block 302, and block 304 depends on block 303. Referring to FIG. 3, block 202 contains a hash reference to block 101, representing a response transaction.

### Snapshot Chain

When the ledger is forked, the result of consensus may swing between two forked ledgers. For example, based on a blockchain structure, if a node receives a longer forked chain, the new fork will be selected as the consensus result, and the original fork will be abandoned and the transaction on the original fork will be rolled back. In such a system, transaction rollback is a very serious event, which will lead to double spend. Just imagine that a merchant receives a payment, provides goods or services, and after that payment is withdrawn, the merchant may suffer losses. Therefore, when a user receives a payment transaction, it is necessary for the user to wait until the system “confirms” the transaction to ensure that the probability of rolling back is low enough.

The probability of transaction rollback decreases with time due to the hash reference relationship in the account structure. As discussed supra, when the design of the ledger has better tampering-proof characteristics, rolling back a transaction needs to reconstruct all subsequent blocks of the transaction in the block. As new transactions are constantly being added to ledgers, there are more and more successive nodes in a transaction, so the probability of being tampered with will decrease.

In the block-lattice structure, as the transaction is grouped by account, a transaction will only be attached to the end of the account chain of its own account, and the transaction generated by most other accounts will not automatically become a successor of this transaction. Therefore, it is necessary to design a consensus algorithm reasonably to avoid potential risk of double spend.

Nano adopts a voting-based consensus algorithm, in which transaction is signed by a set of representative nodes selected by a group of users. Each representative node has a weight. When the signature of a transaction has enough weight, it is believed that the transaction is confirmed.

There are following problems in this algorithm. First, if there are not enough representative nodes online, voting from the majority cannot be guaranteed, and it is possible that a user will never collect enough votes necessary to confirm a transaction. Moreover, if plurality is accepted within fixed voting period, different voting results may be watched by peers located at different spots of the network topology due to poor connection, and cause a split. Second, the probability that transactions are rolled back does not decrease with time. This is because at any time, the cost of overturning a historical voting is the same. Finally, the historical voting results are not persisted into a public distributed ledger but are stored only in the local storage of peers. In other words, these results are not traceable. When a peer requests the ledger data from other peers, there is no trustful way to ensure the data is consistent.

To solve these problems, the method of this disclosure uses a snapshot chain independent of the distributed ledger to store the state snapshots of the ledger. The snapshot chain is a chain structure composed of snapshot blocks, each of the snapshot block (except for the genesis snapshot block) refers to the hash of the previous snapshot block. Each snapshot block records the latest state snapshot of each account chain. In certain embodiments, the state snapshot includes the balance of the account and the hash of the last block in each account chain. In certain embodiments, the state snapshot also includes the Merkle root of the contract state. The first snapshot block in the snapshot chain is called the “genesis snapshot”, which stores the snapshot of the genesis block of at least one account.

FIG. 3 also illustrates a snapshot chain in the exemplary embodiment. Referring to FIG. 3, a snapshot chain comprises a series of snapshot blocks (401, 402 and 403) organized in a chain structure, with each snapshot block refers to the hash of the previous snapshot block (snapshot block 402 refers to the hash of snapshot block 401, and snapshot block 403 refers to the hash of snapshot block 402). A snapshot block stores a state snapshot of the distributed ledger. Referring to FIG. 3, snapshot block 402 stores state snapshots of block 101, 201 and 301; snapshot block 403 stores state snapshots of block 102, 203 and 304.

The snapshot chain remedies the security flaws of a distributed ledger having a block lattice structure. In certain embodiments, if an attacker wants to generate a double spend transaction, in addition to rebuilding the hash reference in the ledger, it also needs to rebuild in the snapshot chain for all the blocks after the first snapshot block of the transaction and need to produce a longer snapshot chain. In this way, the cost of attack will be greatly increased.

Therefore, in a system using snapshot chain, a transaction can be confirmed if the transaction is snapshotted by the snapshot chain. And the depth of the snapshot block when the transaction is first snapshotted is called the confirmation number of the transaction. When the confirmation number increases as the snapshot chain grows, the probability of the double-spend attack decreases. In certain embodiments, users can choose customized confirmation number to wait to meet the desired confidence level according to the specific scenario.

The snapshot chain itself relies on a consensus algorithm. In certain embodiments, if the snapshot chain is forked, the longest fork is chosen as a valid fork. When the snapshot chain is switched to a new fork, the original snapshot information will be rolled back. In this situation, the result of original consensus on the ledger was overturned and replaced by the new consensus result.

In certain embodiments, if all account states need to be saved in every snapshot block in snapshot chain, the storage space will be very large. Therefore, compression of the snapshot chain may be needed.

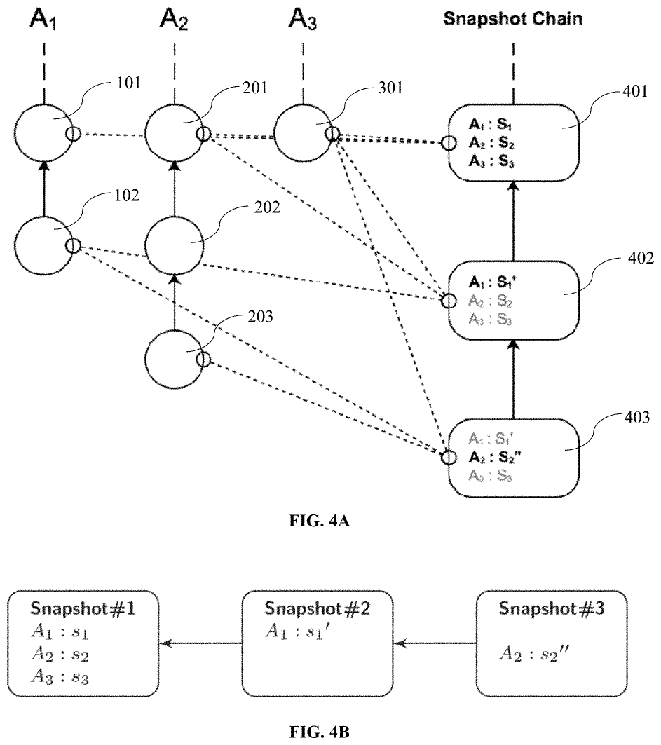

FIGS. 4A and 4B illustrate the compression of snapshot in an exemplary embodiment. The basic approach of compressing snapshot chain storage space is to use incremental storage: a snapshot block only stores data that is changed compared to the previous snapshot chain. If there is no transaction for one account between the two snapshots, the latter snapshot will not save the data of the account. FIG. 4A illustrates the snapshot chain before compression, in which all account states are stored in snapshot block. Referring to FIG. 4A, block chain A₁ includes at least block 101 and block 102; block chain A₂ includes at least block 201, block 202 and block 203; block chain A₃ includes at least block 301. Snapshot chain includes at least snapshot block 401, snapshot block 402 and snapshot block 403. Snapshot block 401 stores state snapshots of block 101 (i.e., S₁), of block 201 (i.e., S₂), and of block 301 (i.e., S₃); Snapshot block 402 stores state snapshots of block 102 (i.e., S₁′), of block 201 (i.e., S₂), and of block 301 (i.e., S₃); Snapshot block 403 stores state snapshots of block 102 (i.e., S₁′), of block 203 (i.e., S₂″), and of block 301 (i.e., S₃). FIG. 4B illustrates the snapshot chain after compression, in which only the final state of each snapshot of an account is stored when snapshotting, and the intermediate state will not be taken into account. Referring to FIG. 4B, Snapshot block #1 stores state snapshots of block 101 (i.e., S₁), of block 201 (i.e., S₂), and of block 301 (i.e., S₃); Snapshot block #2 stores the state snapshot of block 102 (i.e., S₁′) as the state of block chain A₂ and A₃ do not change; Snapshot block #3 stores state snapshots of block 203 (i.e., S₂″). Thus, only one copy of the data in the snapshot will be stored, no matter how many transactions generated by an account between the two snapshots.

### Consensus

The methods disclosed herein can use consensus protocols known in the art. When designing a consensus protocol, at least three factors need to be taken account: (1) performance (speed), (2) scalability, and (3) security. To ensure high throughput and low latency of the system, a consensus algorithm with higher convergence speed is needed. Scalability is an important consideration for a public platform that is open to all kinds of decentralized applications. And the consensus protocol needs to ensure enough safety bottom line and effectively defend against different attacks.

Compared with some existing consensus algorithms, the security of PoW is better, and a consensus can be reached if the hash power of malicious nodes are below 50%. However, the convergence speed of PoW is low and cannot meet the performance requirements. PoS and its variant algorithms remove the steps to solve mathematical problems, improve convergence speed and single attack cost, and reduce energy consumption. But the scalability of PoS is still poor, and the “Nothing at Stake” problem is difficult to solve. BFT (Byzantine fault tolerance) algorithms has better performance in security and performance, but its scalability is a problem, usually more suitable for private chain or consortium chain. The DPoS series algorithm effectively reduces the probability of false fork by limiting the permissions of generating blocks. The performance and scalability are good. As a consequence, DPoS has a slight sacrifice in security, and the number of malicious nodes should not be more than ⅓. Generally, the DPoS algorithm has obvious advantages in performance and scalability. In certain embodiments, the methods provided herein use DPoS or its improvements, such as hierarchical delegated PoS (HDPoS), as the consensus protocol.

In certain embodiments, users can set up consensus groups flexibly and select different consensus parameters on their needs.

In certain embodiments, the snapshot chains use a snapshot consensus group that adopts DPoS as the consensus algorithm. In one example, users can specify snapshot consensus groups with 25 proxy nodes to produce snapshot blocks at intervals of 1 second. This ensures that the transaction is confirmed to be fast enough while achieving 10 times transaction confirmation need to wait 10 seconds in maximum.

In certain embodiments, the private consensus group is used to the production of transaction blocks in ledgers. In one example, the blocks in an account chain can only be produced by the owner of the private key of the account. By default, all user accounts belong to the private consensus group. The greatest advantage of the private consensus group is to reduce the probability of fork. Because only one user has the right to produce blocks, the only possibility of fork is that the user initiates a double spend attack personally or a program error. The disadvantage of the private consensus group is that the user nodes must be online before they can pack the transaction. This is not very suitable for the contract account. Once the owner's node fails, no other node can replace the response transaction that it produces contracts, which is equivalent to reducing the service availability of dApp.

In certain embodiments, a delegated consensus group is used to produce transaction blocks. In the delegate consensus group, instead of user account, a set of designated proxy nodes is used to package the transaction through the DPoS algorithm. Both user accounts and contractual accounts can be added to the consensus group. Users can set up a set of separate agent nodes and establish a new consensus group. In some embodiments, there is also a default consensus group to help package transactions for all the other accounts that haven't established their delegate consensus group individually, which is also known as the public consensus group. The delegate consensus group is suitable for most of the contract accounts, because most of the transactions in the contract account are contract response transactions, in which higher availability and lower delays are needed than the receivable transactions in the user account.

In certain embodiments, the priority of global consensus is higher than that of local consensus. When the local consensus is forked, the result of global consensus selection will prevail. In other words, once the global consensus selected a fork of the local consensus as the final result, even a longer fork of a certain account chain in the future accounts occurs, it will not cause the roll back of the global consensus results.

### Asynchronous Model

In certain embodiments, the methods disclosed herein use an asynchronous model on the consensus mechanism.

The life cycle of a transaction includes transaction initiation, transaction writing and transaction confirmation. In order to improve the performance of the system, these three steps are designed into asynchronous mode. This is because at different times, the quantity of transactions initiated by users is different, the speed of transaction writing and transaction confirmation processed by system is fixed relatively. Asynchronous mode helps to flatten the peaks and troughs thus improve the overall throughput of the system.

The asynchronous model of the Bitcoin and the Ethereum is simple: the transaction initiated by all users is placed in an unconfirmed pool. When the miner packages it into a block, the transaction is written and confirmed at the same time. When the block chain continues to grow, the transaction eventually reaches the preset confirmation confidence level.

There are two problems in this asynchronous model. First, transactions are not persisted to ledgers in an unconfirmed state. Unconfirmed transactions are unstable, and there is no consensus involved, it can't prevent sending of transactions repeatedly. Second, there is no asynchronous mechanism for writing and confirming of transactions. Transactions are only written when confirmed, and the speed of writing is restricted by the confirmation speed.

In certain embodiments, the methods disclosed herein establish a more improved asynchronous model. First, the transaction is split into a transaction pair based on a “request-response” model, whether it is a transfer or a contract call, and the transaction is successfully launched when a request transaction is written to the ledger. In addition, the writing and confirming of a transaction is asynchronous as well. Transactions can be written into the accounts of the DAG ledger first and will not be blocked by the confirmation process. Transaction confirmation is done through snapshot chain, and snapshot action is asynchronous too.

This is a typical producer-consumer model. In the life cycle of the transaction, no matter how production rate changes in the upstream, the downstream can deal with the transaction at a constant rate, so as to fully utilize the platform resources and improve the system's throughput.

It is appreciated that the Summary and Abstract sections may set forth one or more, but not all exemplary embodiments of the present invention as contemplated by the inventor(s), and thus, are not intended to limit the present invention and the appended claims in any way.

1. A method of digital asset transfer or smart contract state transition on a distributed ledger operated on a network, wherein the distributed ledger comprises a plurality of accounts, each account having an account chain comprising a series of blocks linked by hash reference, wherein the network comprises a plurality of nodes each having a processor, the method comprising:
a. receiving, by a node of the network, a latest block of a first account broadcast in the network, wherein the first account is making a transaction with a second account, wherein the first account has a first series of blocks linked by hash reference and the second account has a second series of blocks linked by hash reference;
b. verifying, by the node, that the transaction is valid;
c. taking, by the node, snapshot of the latest block of the first account, wherein the snapshot comprises:
the first account's balance upon completing the transaction, and
a hash of the latest block of the first account; and
d. generating a latest snapshot block of a snapshot chain that records global consensus of the distributed ledger, wherein the snapshot chain is independent of the distributed ledger and comprises a series of snapshot blocks linked by hash reference, and wherein the snapshot is stored in the latest snapshot block of the snapshot chain.

2. The method of claim 1, wherein the distributed ledger has a structure of directed acyclic graph.

3. The method of claim 1, wherein the transaction is a request transaction that sends an amount of digital asset to the second account or invokes a smart contract that is deployed on the second account, wherein the verifying step comprises:
a1. verifying that a hash of a previous block of the first account linked to the latest block of the first account is valid; and
a2. verifying that the first account's balance prior to the transaction is not less than the amount of digital asset.

4. The method of claim 1, wherein the transaction is a response transaction that receives an amount of digital asset or executes a smart contract state transition from a corresponding request block of a second account, wherein the verifying step comprises:
a1. verifying that a hash of a previous block of the first account linked to the latest block of the first account is valid; and
a2. verifying that the hash of a corresponding request block is valid.

5. The method of claim 1, wherein the snapshot further comprises a merkle root of the first account's contract state.

6. The method of claim 1, wherein the latest snapshot block is signed by the node.

7. The method of claim 1, further comprising broadcasting, by the node, the latest snapshot block to the network.

8. A non-transitory readable storage medium including instructions, when executed by a processor in a node of a network, causes the processor to perform a method of digital asset transfer or smart contract state transition on a distributed ledger, wherein the distributed ledger comprises a plurality of accounts, each account having an account chain comprising a series of blocks linked by hash reference, wherein global consensus of the distributed ledger in the network is recorded in a snapshot chain comprising a series of snapshot blocks linked by hash reference, the method comprising:
a. receiving a latest block of a first account broadcast in the network, wherein the first account is making a transaction with a second account, wherein the first account has a first series of blocks linked by hash reference and the second account has a second series of blocks linked by hash reference;
b. verifying that the transaction is valid;
c. taking a snapshot of the latest block of the first account, wherein the snapshot comprises:
the first account's balance upon completing the first transaction, and
a hash of the latest block of the first account; and
d. generating a latest snapshot block of a snapshot chain that records global consensus of the distributed ledger, wherein the snapshot chain is independent of the distributed ledger and comprises a series of snapshot blocks linked by hash reference, and wherein the snapshot is stored in the latest snapshot block of the snapshot chain.

9. The non-transitory readable storage medium of claim 8, wherein the distributed ledger has a structure of directed acyclic graph.

10. The non-transitory readable storage medium of claim 8, wherein the transaction is a request transaction that sends an amount of digital asset to the second account or invokes a smart contract that deployed on the second account, wherein the verifying step comprises:
a1. verifying that a hash of a previous block of the first account linked to the latest block of the first account is valid; and
a2. verifying that the first account's balance prior to the transaction is not less than the amount of digital asset.

11. The non-transitory readable storage medium of claim 8, wherein the transaction is a response transaction that receives an amount of digital asset or executes a smart contract state transition from a corresponding request block of a second account, wherein the verifying step comprises:
a1. verifying that a hash of a previous block of the first account linked to the latest block of the first account is valid; and
a2. verifying that the hash of a corresponding request block is valid.

12. The non-transitory readable storage medium of claim 8, wherein the snapshot further comprises a merkle root of the first account's contract state.

13. The non-transitory readable storage medium of claim 8, wherein the latest snapshot block is signed by the node.

14. The non-transitory readable storage medium of claim 8, wherein the method further comprises broadcasting the latest snapshot block to the network.

15. (canceled)

16. (canceled)

17. (canceled)

18. (canceled)

19. (canceled)

20. (canceled)
